(19) United States
(12) Patent Application Publication
(10) Pub. No.: US 2020/0055174 A1
(43) Pub. Date: Feb. 20, 2020

(54) MODULAR TOOL SYSTEM

(71) Applicant: ROBBOX INC., Richmond (CA)

(72) Inventor: Andrei MATEI, Coquitlam (CA)

(73) Assignee: ROBBOX INC., Richmond (CA)

(21) Appl. No.: 16/598,693

(22) Filed: Oct. 10, 2019

Related U.S. Application Data
(63) Continuation of application No. 15/389,464, filed on Dec. 23, 2016.

(51) Int. Cl. B25F 3/00; G06K 19/07; G06K 7/10; B66F 3/44; B25B 21/00; B24B 23/02; A61G 5/04; A47L 5/24; A01D 34/416; A61G 5/12; A47L 9/28

(52) U.S. Cl. CPC B25F 3/00; G06K 19/0723; G06K 7/10366; B66F 3/44; B25B 21/00; B24B 23/028; A61G 5/047; A47L 5/24; A01D 34/416; A61G 5/125; A47L 9/2805; A47L 9/2884; A61G 2203/14; A61G 5/045

(57) ABSTRACT

A modular tool system is disclosed herein with a power unit, a battery, a controller, a sensor, and a plurality of tool modules. The hand-held sized power unit can include a motor housing and a motor with a shaft. The controller can variably control the shaft. Each tool module can include a housing, a work-engaging portion, a transmission linkage, and an identifier. The identifier is within a range of detection of the sensor when the housings are coupled. Each of the identifiers is distinguishable from other identifiers and the sensor transmits a different signal for each of the identifiers. The controller is configured to determine one of a plurality of different shaft speeds or one of a plurality of different torques to transmit through the shaft in response to the signal from the sensor indicating a particular identifier.

### CROSS-REFERENCE TO RELATED APPLICATIONS

The present application is a continuation of U.S. patent application Ser. No. 15/389,464, filed Dec. 23, 2016, the teaching of which is incorporated by reference herein in its entirety for all purposes.

### BACKGROUND OF THE INVENTION

### Field

The present disclosure relates to a system of tools having a power system interchangeable among and usable with all of the tools.

### Description of the Related Art

U.S. Pat. Pub. No. 2014/0107853 discloses a SYSTEM FOR ENHANCING POWER TOOLS. A system includes a power tool battery pack, a power tool, a portable power supply, a non-motorized sensing tool, and/or a power tool battery pack charger. A separate computing device, such as a smartphone, tablet or computer, communicates wirelessly with the power tool battery pack, the power tool, the portable power supply, the non-motorized sensing tool, and/or the power tool battery pack charger. The computing device monitors a data value representative of a condition of the power tool battery pack, the power tool, the portable power supply, the non-motorized sensing tool, and/or the power tool battery pack charger, and performs an action responsive to the monitored data value.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

A modular tool system can include a power unit, at least one battery, a controller, a sensor, and a plurality of tool modules. The power unit can include a motor housing and a motor at least partially positioned within the motor housing. The motor can include a shaft at least partially contained within the motor housing. The power unit is hand-held in size. The motor and the at least one battery are selectively disposed in electrical communication with one another such that the at least one battery can selectively power the motor. The shaft can be driven in rotation when the motor is powered by the at least one battery. The controller can he mounted at least partially in the motor housing and can be configured to variably control electrical communication between the at least one battery and the motor, whereby a speed of rotation of the shaft and a level of torque communicated through the shaft is variable. The sensor can be disposed in electrical communication with the controller and can be mounted at least in part on an exterior surface of the motor housing. Each of the plurality of tool modules can include a tool module housing individually engageable with the motor housing of the power unit. Each of the plurality of tool modules can include a work-engaging portion and a transmission linkage engageable with the shaft whereby the work-engaging portion is driven to motion by the transmission linkage when the transmission linkage is engaged with the shaft and the motor housing and the tool module housing are coupled together. Each of the plurality of tool modules can also include an identifier mounted at least in part on an exterior surface of the tool module housing. The sensor and the identifier can be respectively positioned on the motor housing and the tool module housing such that the identifier is within a range of detection of the sensor when the motor housing and the tool module housing are coupled together. Each of the identifiers is unique and distinguishable from the other of the identifiers and the sensor is configured to transmit a different signal for each of the identifiers. The controller is configured to determine one of a plurality of different speeds to drive the shaft or one of a plurality of different torques to transmit through the shaft in response to a signal from the sensor indicative of a particular one of the identifiers.

### BRIEF DESCRIPTION OF THE DRAWINGS

The detailed description set forth below references the following drawings:

FIG. 1A is a first exploded view of a power unit, a battery, and a portion of tool module incorporating an exemplary embodiment of the present disclosure;

FIG. 1B is a second exploded view of a power unit, a battery, and a portion of tool. module incorporating an exemplary embodiment of the present disclosure;

FIG. 2 is a partially-exploded view of a power unit, a battery, and a portion of tool module incorporating an exemplary embodiment of the present disclosure;

FIG. 3 is a schematic of electrical components of the exemplary embodiment of the present disclosure;

FIG. 4 is a perspective view of an exemplary embodiment of the present disclosure wherein a tool module is further defined as a grass trimmer;

FIG. 5 is a magnified portion of FIG. 4 with a part of the tool module cut-away to reveal internal components;

FIG. 6A is a first perspective and exploded view of an exemplary embodiment of the present disclosure wherein a tool module is further defined as a grinder;

FIG. 6B is a second perspective and exploded view of the exemplary embodiment of the present disclosure wherein the tool module is further defined as a grinder with a portion cut-away to reveal internal structures:

FIG. 7 is a perspective view of an exemplary embodiment of the present disclosure wherein a tool module is further defined as a wheelchair;

FIG. 8 is a perspective view of an exemplary embodiment of the present disclosure wherein a tool module is further defined as a drill;

FIG. 9A is a perspective view of an exemplary embodiment of the present disclosure wherein a tool module is further defined as a vacuum;

FIG. 9B is a partial perspective view of the exemplary embodiment of the present disclosure wherein the tool module is further defined as a vacuum with a portion cut-away to reveal internal structures;

FIG. 9C is a planar view of the perspective view of FIG. 9B;

FIG. 10 is a perspective view of an exemplary embodiment of the present disclosure wherein a tool module is further defined as a wheelchair;

FIG. 11 is a flow diagram of an example method according to some implementations of the present disclosure;

FIG. 12 is a first perspective view of an exemplary embodiment of the present disclosure; and

FIG. 13 is a second perspective view of the exemplary embodiment of the present disclosure shown in FIG. 12.

### DETAILED DESCRIPTION

The present disclosure, as demonstrated by the exemplary embodiments described below, provides a modular tool system. The modular tool system can include a power unit, a battery, a controller, a sensor, and a plurality ref tool modules. Each tool module can be used to perform different task, such as drilling, grinding, sawing, and outdoor trimming, for example. These tasks are currently performed by tools in the art that are hand-held in size, capable of being held in the hand of the user while in use. The modular tool system of the present disclosure also includes tool modules are hand-held in size. In addition, the modular tool system of the present disclosure also includes tool modules that are not used while being held in the hand of the user, such as a wheelchair, a jack, and a vacuum, for example. The same power unit, which is itself capable of being held in the hand of the user, can be utilized to power such tool modules that are not used while being held in the hand of the user. The power unit can include any number of batteries in view of the power requirements associated with the tool module.

A plurality of different embodiments of tool modules associated with the present disclosure is shown in the Figures of the application. Similar features of tool modules are shown in the various embodiments of the present disclosure. Similar features of tool modules across different embodiments have been numbered with a common reference numeral and have been differentiated by an alphabetic suffix. Similar features of tool modules in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

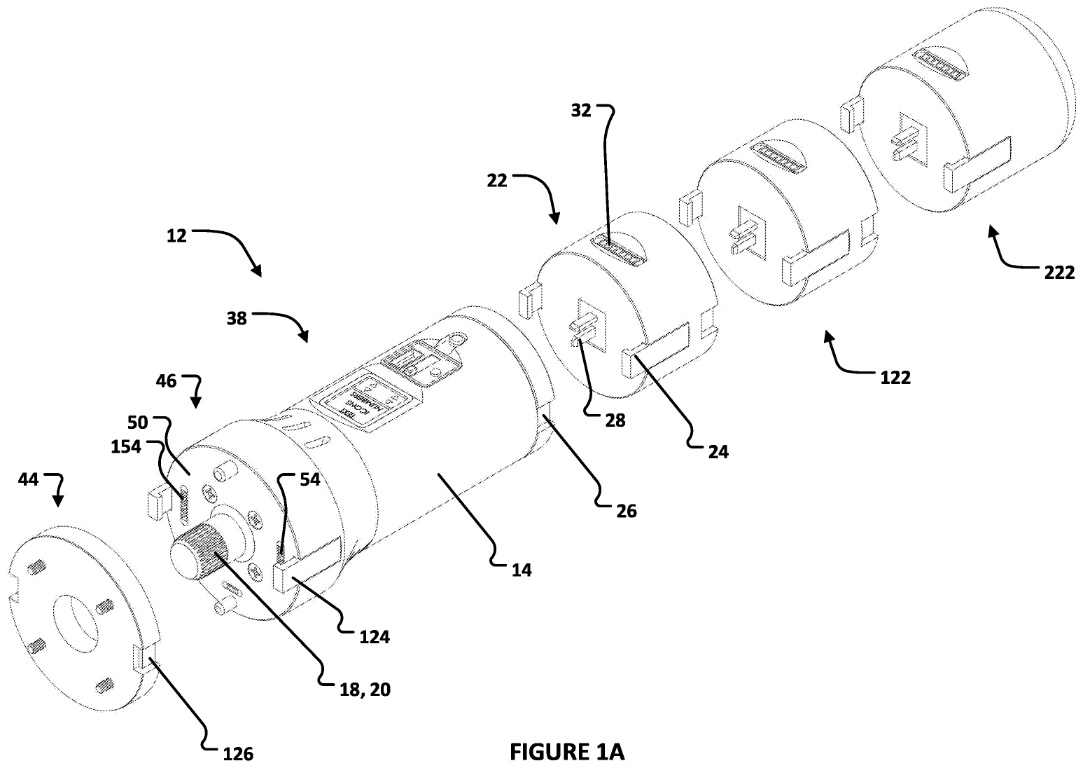

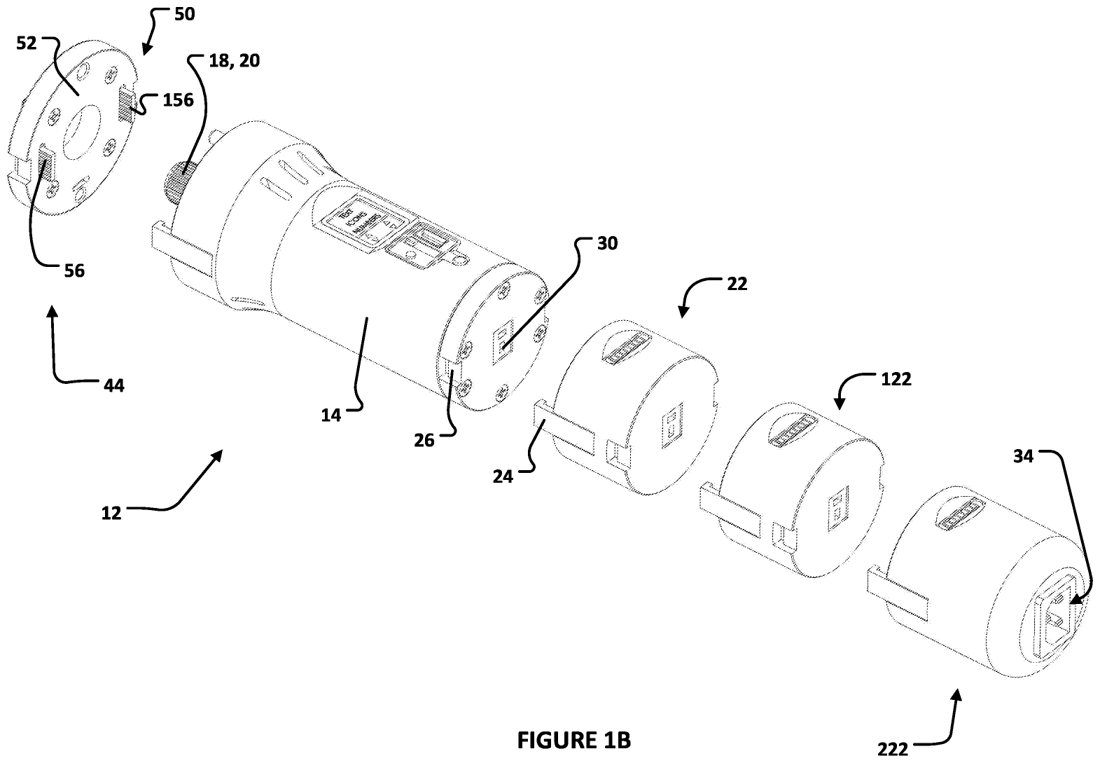

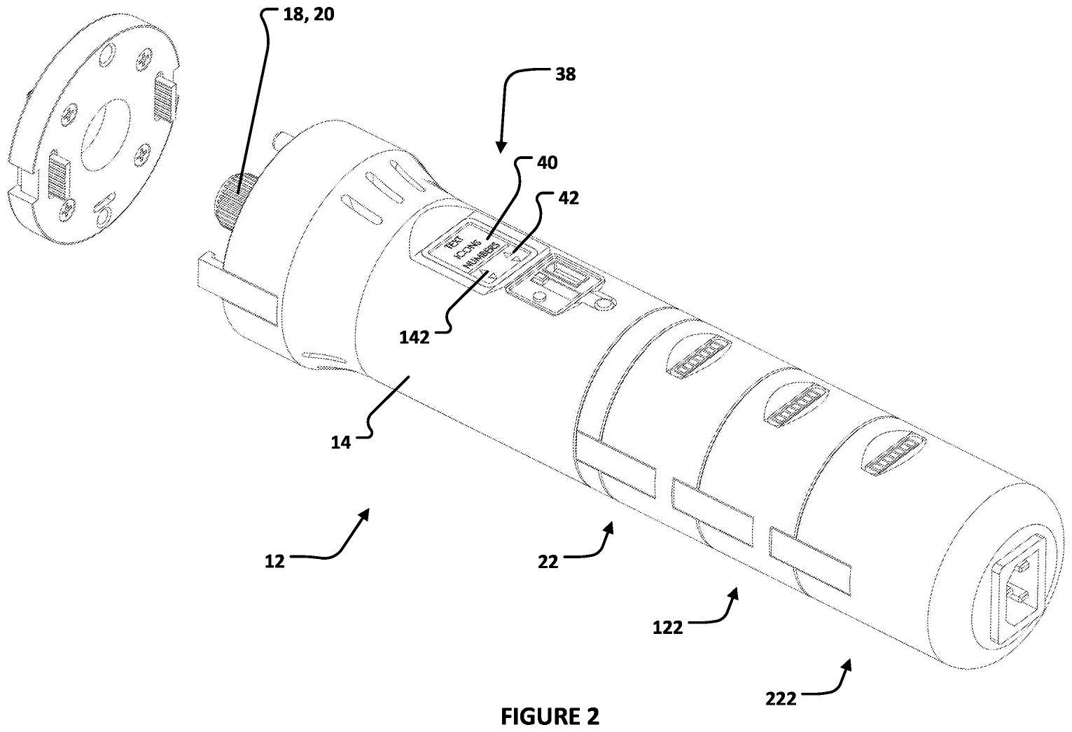

A power unit according to an exemplary embodiment of the present disclosure is shown in FIGS. 1A-3 and referenced at 12. The power unit 12 can include a motor housing 14 and a motor 16 at least partially positioned within the motor housing 14. The exemplary motor housing 14 is cylindrical. The exemplary motor 16 is disposed fully in the motor housing 16 and therefore not visible in FIGS. 1 and 2. The exemplary motor 16 can include a shaft 11 protruding through the motor housing 14. In other embodiments, the shaft of the motor can be contained within the motor housing. Splines 20 are defined at the end of the exemplary shaft 18.

The power unit 12 is hand-held in size. The power unit 12 can be sized less than ten inches in diameter. Power units according to one or more embodiments of the present disclosure can be sized less than seven inches in diameter or less than six inches in diameter or between one to five inches in diameter. The power unit 12 can weigh less than ten pounds. Power units according to one or more embodiments of the present disclosure can weigh less than seven pounds.

The modular tool system 10 also includes at least one battery. The exemplary modular tool system 10 includes batteries 22, 122, 222. The batteries 22, 122, 222 mechanically and electrically coupled in series. The exemplary batteries 22, 122, 222 can be mechanically coupled to one another, releasibly coupled, through snap arms and slots receiving the snap arms. An exemplary snap arm is referenced at 24 and an exemplary slot is referenced at 26. The exemplary batteries 22, 122, 222 are electrically coupled to one another, releasibly coupled, through mating male plugs and female sockets. An exemplary male plug is referenced at 28 and an exemplary female socket is referenced at 30. Each of the batteries 22, 122, 222 can define a recharging port, such as recharging port 32. The battery 222 can define a port 34 configure to receive power from the grid.

The motor 16 and the batteries 22, 122, 222 are selectively disposed in electrical communication with one another such that the batteries 22, 122, 222 can selectively power the motor 16. The shaft 18 can be driven in rotation when the motor 16 is powered by the batteries 22, 122, 222. A user can utilize any one or more of the batteries 22, 122, 222 to provide power to the shaft 18.

The modular tool system 10 also includes a controller 36. The controller 36 can be mounted at least partially in the motor housing 14 and can he configured to variably control electrical communication between the batteries 22, 122, 222 and the motor 16, As a result. the speed of rotation of the shaft 18 and a level of torque communicated through the shaft 18 is variable. The modular tool system 10 can also include a user interface 38 mounted in the motor housing 14 to allow a user to access the controller 36. Through a display 40 or one or more buttons 42, 142 of the user interface 38, the user can access the controller 36 and change the output of the shaft 18 if desired.

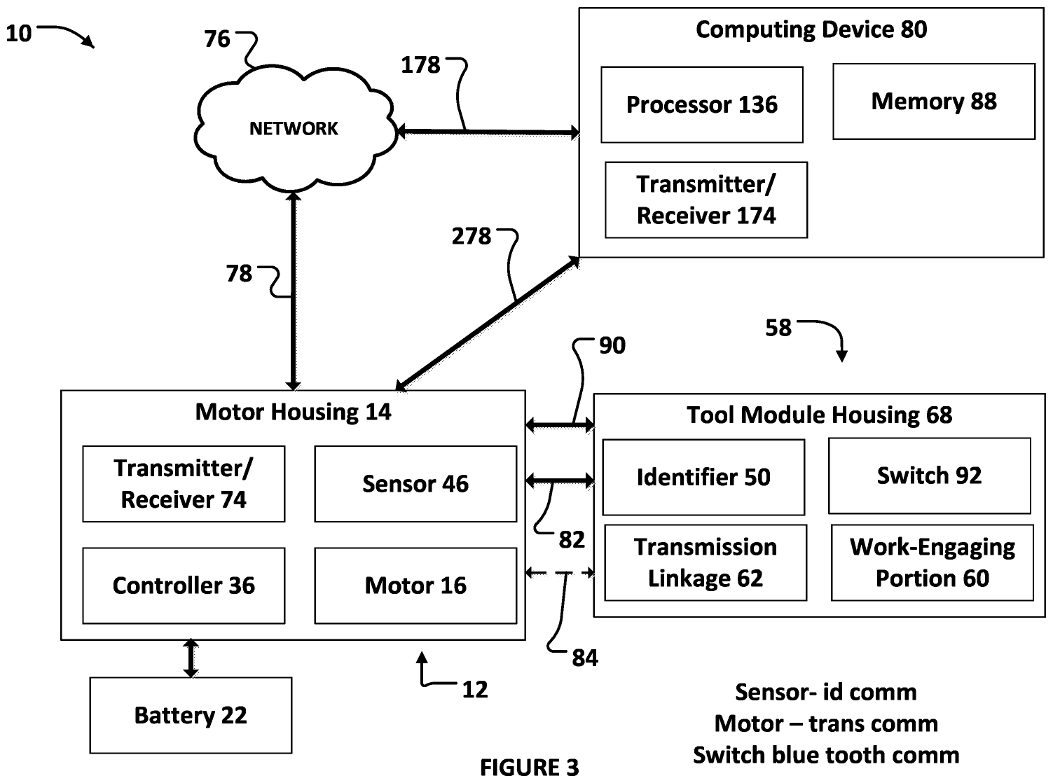

The modular tool system 10 also includes a plurality of tool modules. Each of the tool modules can include a tool module housing individually engageable with the motor housing 14 of the power unit 12. A portion that can be common to all or some of the tool modules is a collar referenced in FIGS. 1A-2 at 44. Each of the plurality of tool modules can include a work-engaging portion and a transmission linkage engageable with the shaft 18 whereby the work-engaging portion is driven in motion by the transmission linkage when the transmission linkage is engaged with the shaft 18 and the motor housing 14 and the tool module housing are coupled together. The transmission of mechanical power to the tool module is referenced at 84 in FIG. 3. The motor housing 14 can directly engage the collar 44 of the tool module housing in one or more embodiments of the present disclosure. The motor housing 14 and the collar 44 can interconnect with one another, releasibly interconnected, through snap arms and slots receiving the snap arms. An exemplary snap arm is referenced in FIG. 1A at 124 and an exemplary slot is referenced at 126.

The modular tool system 10 also includes a sensor 46 that can he disposed in electrical communication with the controller 36. The sensor 46 can be mounted at least in part on an exterior surface 48 of the motor housing 14. Each of the plurality of tool modules can include an identifier 50 mounted at least in part on an exterior surface of the tool module housing, such as a portion of the exterior surface 52 of the collar 44. The sensor 46 and the identifier 50 can be respectively positioned on the motor housing 14 and the tool module housing such that the identifier 50 is within a range of detection of the sensor 46 when the motor housing 14 and the tool module housings are coupled together. The sensor 46 and identifier 50 can be in physical contact or can be spaced from one another when the sensor 46 detects or reads the identifier 50. Detection or reading of the identifier 50 by the sensor 46 is referenced at 82 in FIG. 3.

Each of the identifiers 50 is unique and distinguishable from the other of the identifiers 50, The sensor 46 is configured to transmit a different signal to the controller 36 fir each of the identifiers 50. In the exemplary embodiment, the sensor 46 is a pair of female sockets 54, 154 and the identifier 50 is a pair of male plugs 56, 156. The male plugs 56, 156 are received in the female sockets 54, 154. In one or more embodiments, the male plugs 56, 156 and the female sockets 54, 154 can bare electrical contacts that form one or more circuits when the motor housing 14 and the tool module housings are coupled together. Attributes of the circuit, such as resistance can be utilized to render each identifier unique. Alternatively, radio frequency identification (RFID) tags can be embedded in the male plugs 56, 156 and RFID readers can be positioned at the female sockets 54, 154 to render each identifier unique. Alternatively, a magnetic strip can be disposed on at least one of the male plugs 56, 156 and a reader (such as a credit card reader) can be positioned at the female sockets 54, 154 to render each identifier unique.

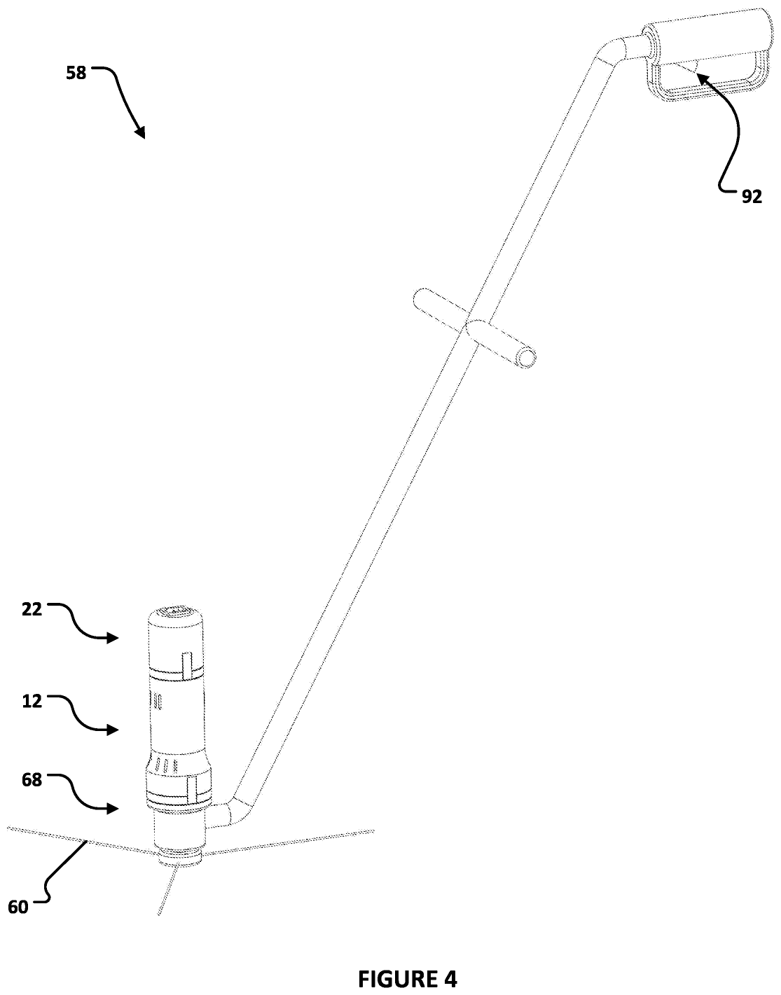

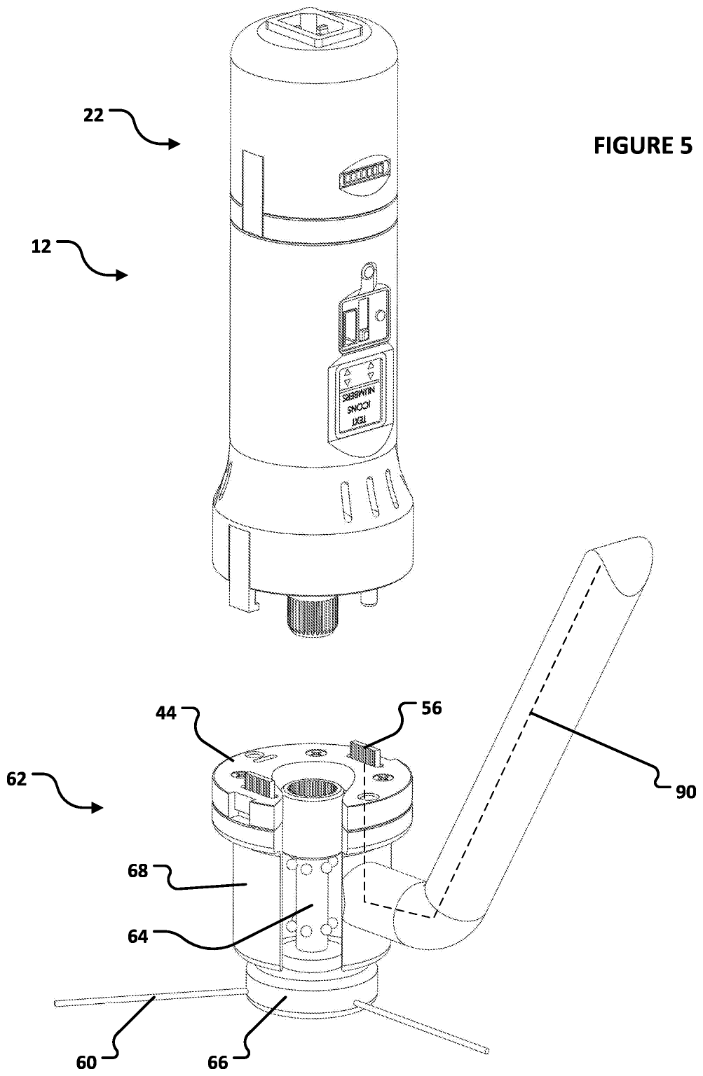

Each of the plurality of tool modules includes a work-engaging portion and a transmission linkage engageable with the shaft 18. FIGS. 4 and 5 are perspective views of an exemplary embodiment of the present disclosure wherein a tool module is further defined as a grass trimmer 58. The grass trimmer 58 includes a work-engaging portion 60 in the form of string. The grass trimmer 58 also includes a transmission linkage 62. The transmission linkage 62 includes a shaft 64 with internal splines to mesh with the splines 20 on the shall 18. The shaft 64 extends through a tool module housing 68 that includes the collar 44. The transmission linkage 62 also includes a hub 66 fixed to the shaft 64 for concurrent rotation. The string 60 extends from the hub 66 and is fixed to the hub 66 and the shaft 64 for concurrent rotation.

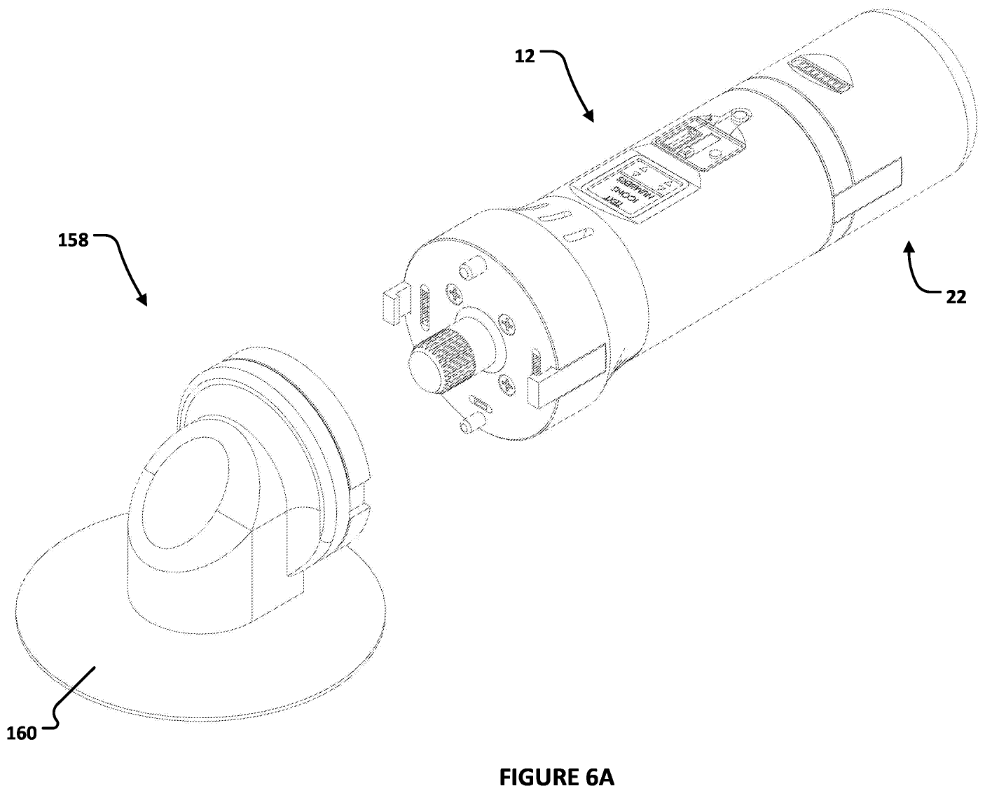

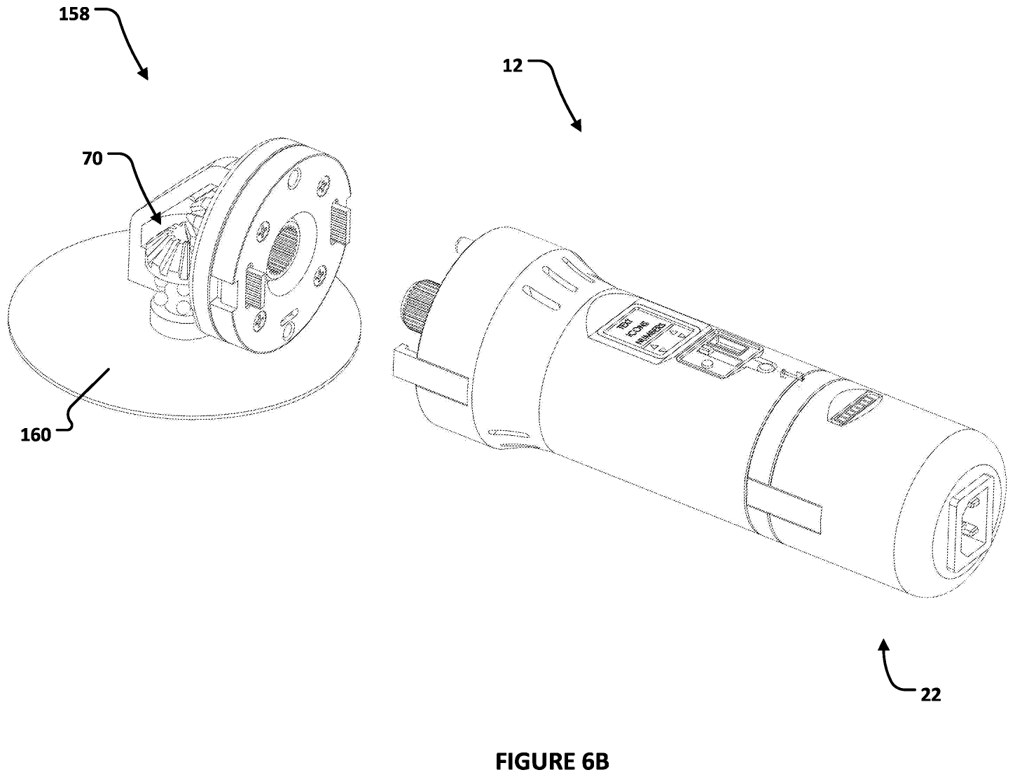

FIGS. 6A and 6B are perspective and exploded views of an exemplary embodiment of the present disclosure wherein a tool module is further defined as a grinder 158. The grinder 158 includes a work-engaging portion 160 in the form of a grinding wheel. The grinder 158 also includes a transmission linkage that can include a pair of bevel gears, such as bevel gear 70. The bevel gear 70 can include internal splines to mesh with the splines 20 on the shaft 18.

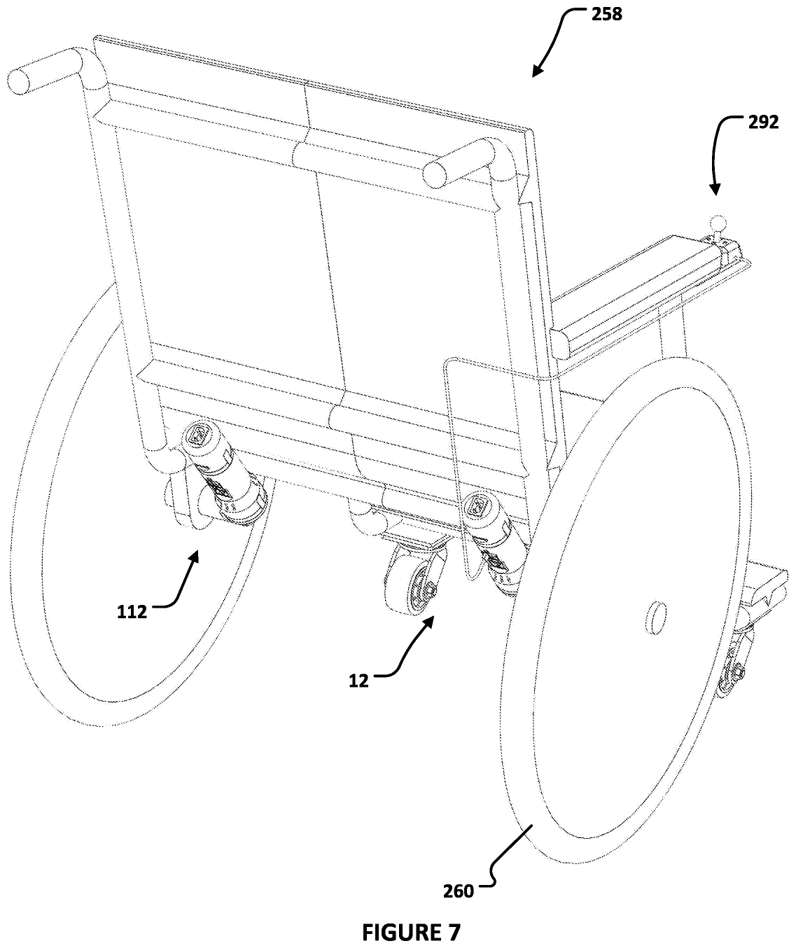

FIG. 7 is a perspective view of an exemplary embodiment of the present disclosure wherein a tool module is further defined as a wheelchair. The wheelchair 258 includes a work-engaging portion 260 in the form of a wheel. The wheelchair 258 also includes a transmission linkage that can include one or more bevel gears, such as bevel gear 70 of the tool module 158. The wheelchair 258 can be powered by a pair of power units 12 and 112, one for each wheel.

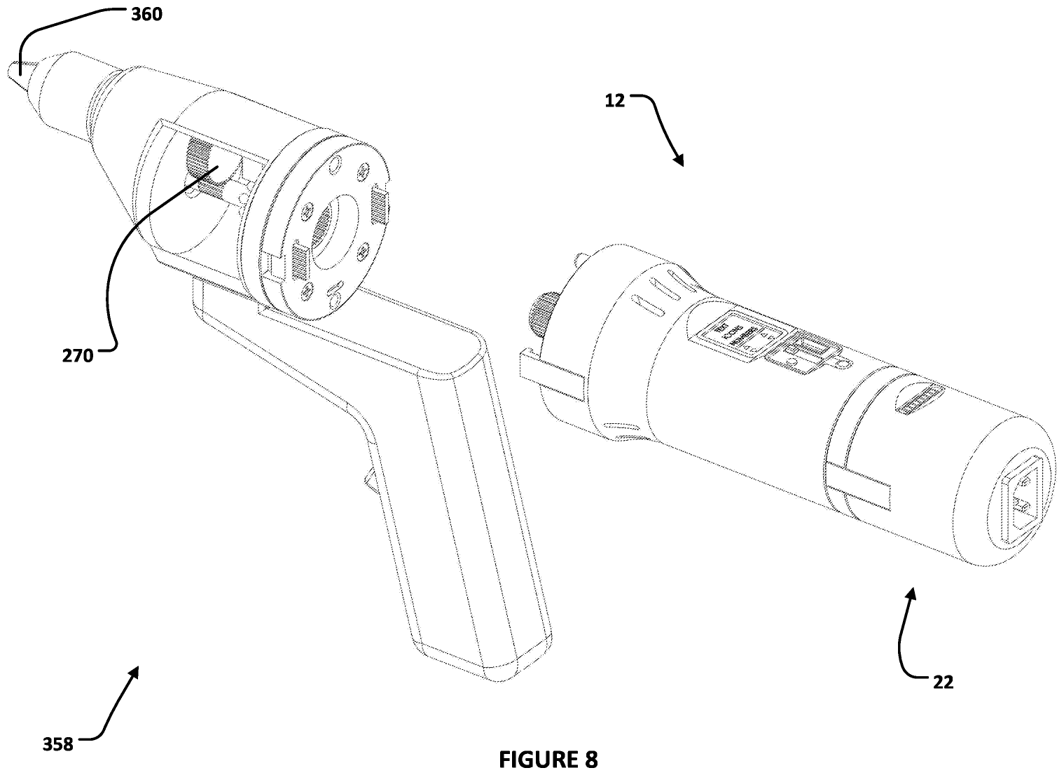

FIG. 8 is a perspective view of an exemplary embodiment of the present disclosure wherein a tool module is further defined as a drill. The drill 358 includes a work-engaging portion 360 including a drill bit chuck. The drill 358 also includes a transmission linkage that can include one or more gears, such as gear 170. The drill 358 can be powered by the power unit 12 including the battery 22.

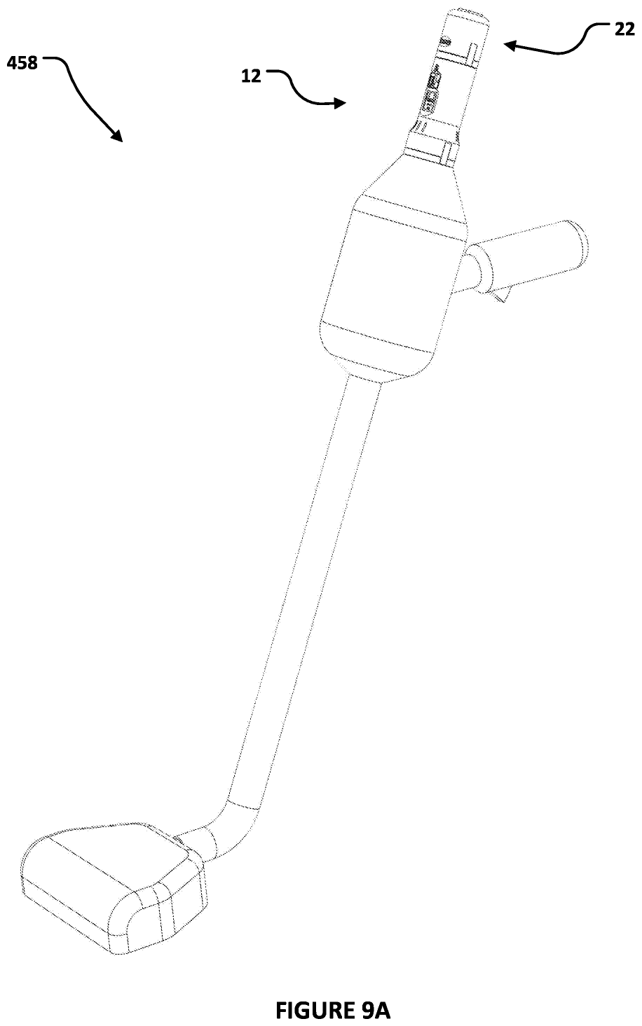

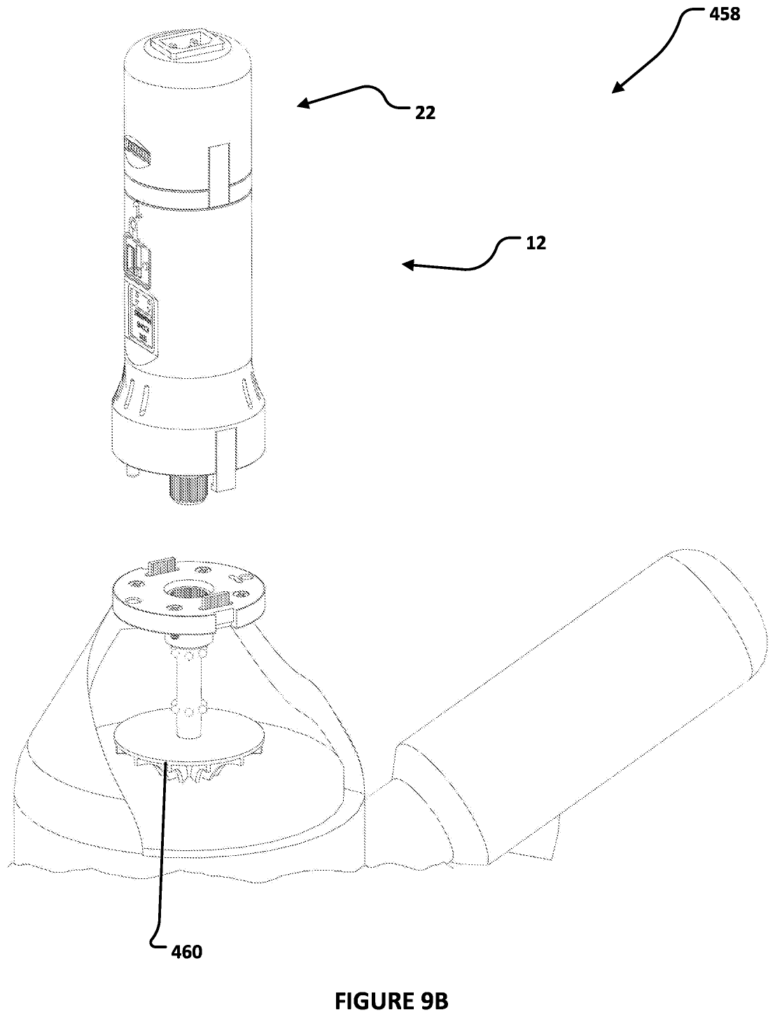

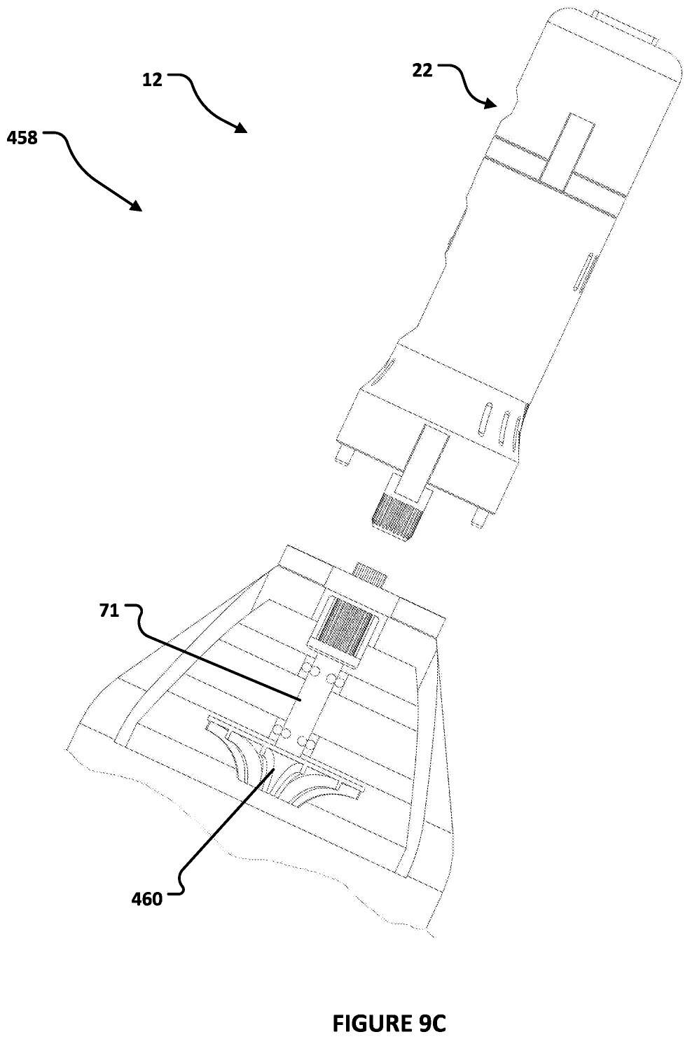

FIGS. 9A-9C are various views of an exemplary embodiment of the present disclosure wherein a tool module is further defined as a vacuum. The vacuum 458 includes a work-engaging portion 460 in the form of a fan. The vacuum 458 also includes a transmission linkage that can include a secondary shaft, such as shaft 71. The shaft 71 can be interconnected to the motor shall through splines. The vacuum 458 can be powered by a pair of power units 12 including battery 22.

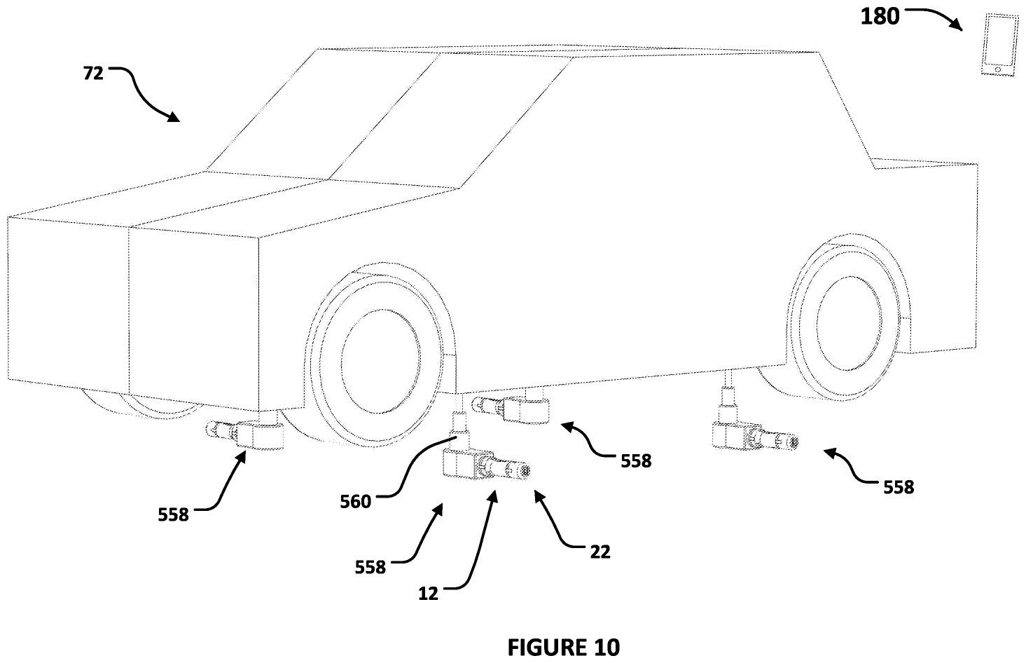

FIG. 10 is a perspective view of an exemplary embodiment of the present disclosure wherein a tool module is further defined as a hydraulic jack. The jack 558 includes a work-engaging portion 560 including a telescoping cylinder extended by a hydraulic pump of the work-engaging portion 560. The jack 558 also includes a transmission linkage that can converts rotation of the shaft 18 into extension of the telescoping cylinder 560 through hydraulic fluid pressure build by rotation of the hydraulic pump. The shaft rotates the hydraulic pump that builds up hydraulic pressure and push upwards the hydraulic cylinders. A plurality of jacks 558 can be utilized together to lift a vehicle 72.

Referring again to FIG. 3, the controller 36 is configured to determine one of a plurality of different speeds to drive the shaft 18 or one of a plurality of different torques to transmit through the shaft 18 in response to a signal from the sensor 46 indicative of a particular one of the identifiers 50. The controller 36 can also be configured to communicate wirelessly with other devices to allow a user to control a tool module remotely. The capacity for communication with external devices also allows a user to control more than one tool module at the same time. Further, the capacity for communication with external devices allows for data gathering to monitor the life and maintenance of the tool modules.

The modular tool system 10 can also include a transmitter 74 in electrical communication with the controller 36. The controller 36 is configured to transmit and receive signals wirelessly by the transmitter 74. The controller 36 is configured to communicate over a network 76 or locally. The network 76 can include a local area network (LAN), a wide area network (WAN), the Internet, or a combination thereof. Lines 78, 178 represent communication between the controller 36 and a computing device 80 over the network 76. Local communication can be accomplished based on Bluetooth® standards for exchanging data over short distances by using short-wavelength radio transmissions, and thus creating personal area network (PAN). Line 278 represents communication between the controller 36 and a computing device 80 by Bluetooth® standards. The transmitter 74 can also apply 3G or 4G, which is defined by the International Mobile Telecommunications-2000 (IMT-2000) specifications promulgated by the International Telecommunication Union.

The computing device 80 can have one or more processors, such as processor 136, transmitter/receiver 174, and memory 88. The computing device 80 can be operated by a user of the system 10 and allow the user to control operation of the power unit 12. While a single computing device 10 is described and referred to hereinafter, it should be appreciated that a computing device according to one or more implementations of the present disclosure can be cooperatively defined by structures that are physically remote from one another, such, for example, a server and smartphone. Examples of the computing device 80 include desktop computers, laptop computers, tablet computers, mobile phones, and smart televisions. In sonic embodiments, the computing device 80 can be a mobile computing device associated with the user. In some embodiments, the computing device 80 can be a server, wherein input from the user is received by the computing device 80 from another computing device associated with the user.

The processor 136 can be configured to control operation of the computing device 80. It should be appreciated that the term “processor” as used herein can refer to both a single processor and two or more processors operating in a parallel or distributed architecture. The processor 136 can operate under the control of an operating system, kernel and/or firmware and can execute or otherwise rely upon various computer software applications, components, programs, objects, modules, data structures, etc. Moreover, various applications, components, programs, objects, modules, etc. may also execute on one or more processors in another computing device coupled to processor 136, e.g., in a distributed or client-server computing environment, whereby the processing required to implement the functions of embodiments of the present disclosure may be allocated to multiple computers over the network 74. The processor 136 can be configured to perform general functions including, but not limited to, loading/executing an operating system of the computing device 80, controlling communication via the transmitter 174, and controlling read/write operations at the memory 88. The processor 136 can also be configured to perform specific functions relating to at least a portion of the present disclosure including, but not limited to, loading/executing a tool module operating application, comparing tool module use to a table correlating use with a maintenance schedule, and monitoring operational parameters of tool modules currently in use.

Memory 88 can be defined in various ways in implementations of the present disclosure. Memory 88 can include computer readable storage media and communication media. Memory 88 can be non-transitory in nature, and may include volatile and non-volatile, and removable and non-removable media implemented in any method or technology for storage of information, such as computer-readable instructions, data structures, program modules or other data. Memory 88 can further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium that can be used to store the desired information and which can be accessed by the processor 136. Memory 88 can store computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

In one example of user control over the system 10, the system 10 can include a switch 92 mounted on the tool module 58. The switch 92 can be grasped by hand and can be configured to wirelessly communicate with the controller 36 through the transmitter 74. The switch 92 can be engaged by the user to activate the motor 16. The controller 36 can engage the motor 16 when the user squeezes the switch 92. The communication between the controller 36 and the switch 92 can occur by short-wavelength radio transmissions. The switch 92 can receive power from the battery 22 over a power line 90. The power line 90 extends from the battery, across the interconnected plug 56 and socket 54, to the switch 92. The switch 92 can communicate with the power unit 12 over line 90 or wirelessly.

FIG. 7 shows a switch 292 in the form of a joystick. The joystick 292 can communicate with the power units 12, 112 so that each power unit 12, 112 will receive appropriate signals. For example, when the joystick 292 is pressed straight forward and straight backward, both power units 12, 112 can be activated to rotate in the same direction and at the same speed so that the wheelchair 258 moves straight in a forward or backward direction. Alternatively, if the joystick 292 is pressed precisely to the left or right, only one of the power units 12, 112 can be activated to rotate or both of the units 12, 112 can be activated to rotate in opposite directions. The switch 292 can communicate with the power units 12, 112 over a wire or wirelessly.

In another example of user control over the system 10, the system 10 can be controlled by a computing device 180, as shown in FIG. 10. The computing device 180 can be a smartphone of the user. The communication between the controller 36 and the computing device 180 can occur by short-wavelength radio transmissions or a network. The modular tool system 10, including four, identical tool modules 558 can be controlled concurrently to lift the vehicle at four positions at the same rate.

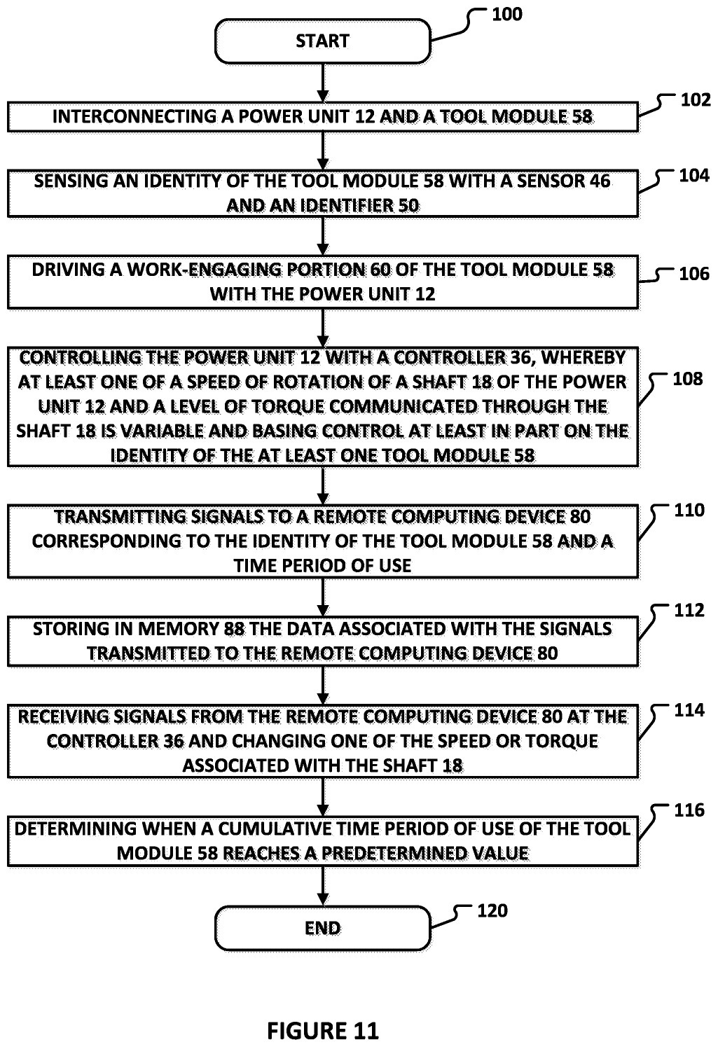

FIG. 11 is a flow diagram of an example method according to some implementations of the present disclosure. The flowchart and block diagrams in the flow diagram illustrates the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical functions. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The method illustrated in FIG. 11 can be executed by the system 10. The method starts at 100. At 102, the power unit 12 and a tool module 58 are interconnected. The mechanical and electrical connection can occur concurrently. At 104, an identity of the tool module 58 is sensed with a sensor 46 and an identifier 50. At 106, a work-engaging portion 60 of the tool module 58 is driven in motion with the power unit 12. At 108, the operation of the power unit 12 is controller with a controller 36, whereby at least one of a speed of rotation of a shaft 18 of the power unit 12 and a level of torque communicated through the shaft 18 is variable. Control is based at least in part on the identity of the at least one tool module 58. At 110, signals are transmitted to a remote computing device 80 corresponding to the identity of the tool module 58 and a time period of use. At 112, data associated with the signals transmitted to the remote computing device 80 is stored in memory. The signals can indicate the current operational parameters of the power unit 12 (shaft speed and/or torque for example). The computing device 80 can process these signals to determine if the current operational parameters of the power unit 12 should change. If the computing device 80 determines that the current operational parameters of the power unit 12 should change, the computing device 80 can, at 114, emit signals receiving by the controller 36 that compel the controller 36 to change one of the speed or torque associated with the shaft 18. At 116, the computing device 80 can determining when a cumulative time period of use of the tool module 58 reaches a predetermined value. For example, the computing device 80 can track and identify when the tool module 58 has been used for a period of ten hours.

The data gather on tool module usage can be used in various ways. In one or more embodiments of the present disclosure, tool module usage can be stored and applied to associate the usage with particular job assignments or job numbers. This can enhance the planning and cost estimating for future jobs. In one or more embodiments of the present disclosure, maintenance alerts can be emitted by the remote computing device 80 in response to the determining. For example, when a tool module has been used for a period of ten hours the computing device can emit a maintenance alert that all bearings of that tool module should be lubricated. The maintenance alert can be emitted at the computing device, visually through a display (pop-up window, text message or email) or audibly through a speaker, The alert can be communicate through a display screen or speaker mounted on the power unit. The exemplary method ends at 120.

It is noted that, in one or more embodiments of the present disclosure, the tool modules or the power units or the batteries can include global positioning sensors to associate tool module usage with a particular geographic location. Position data can be correlated to job numbers and to particular tool modules.

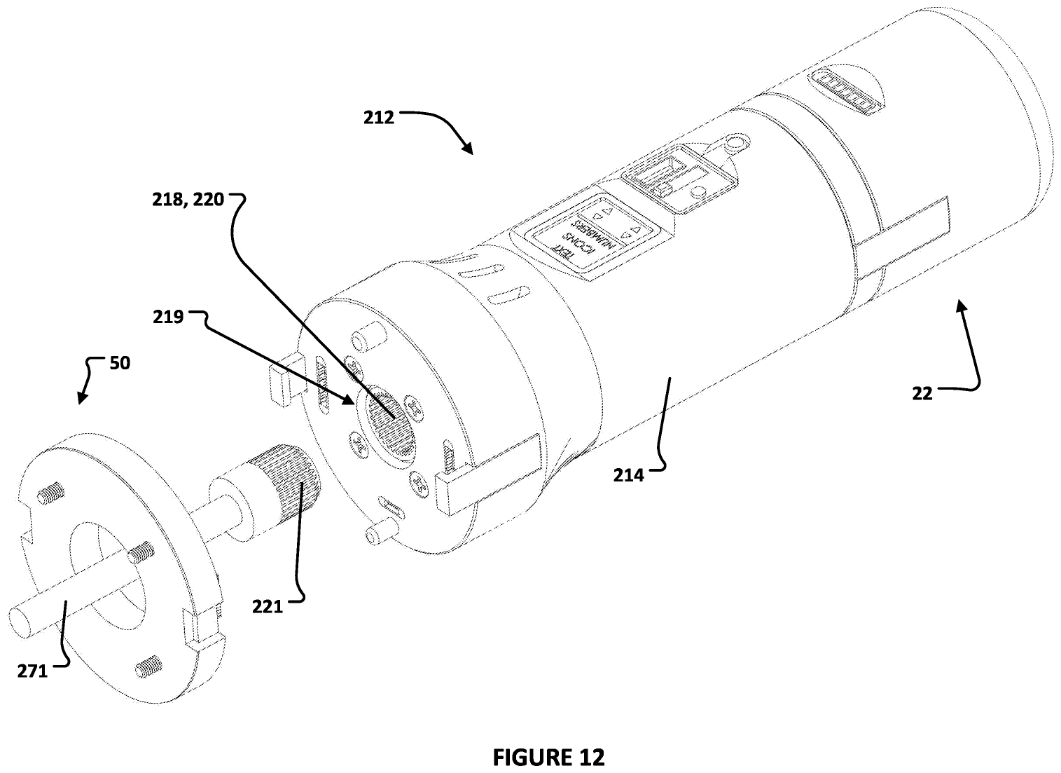

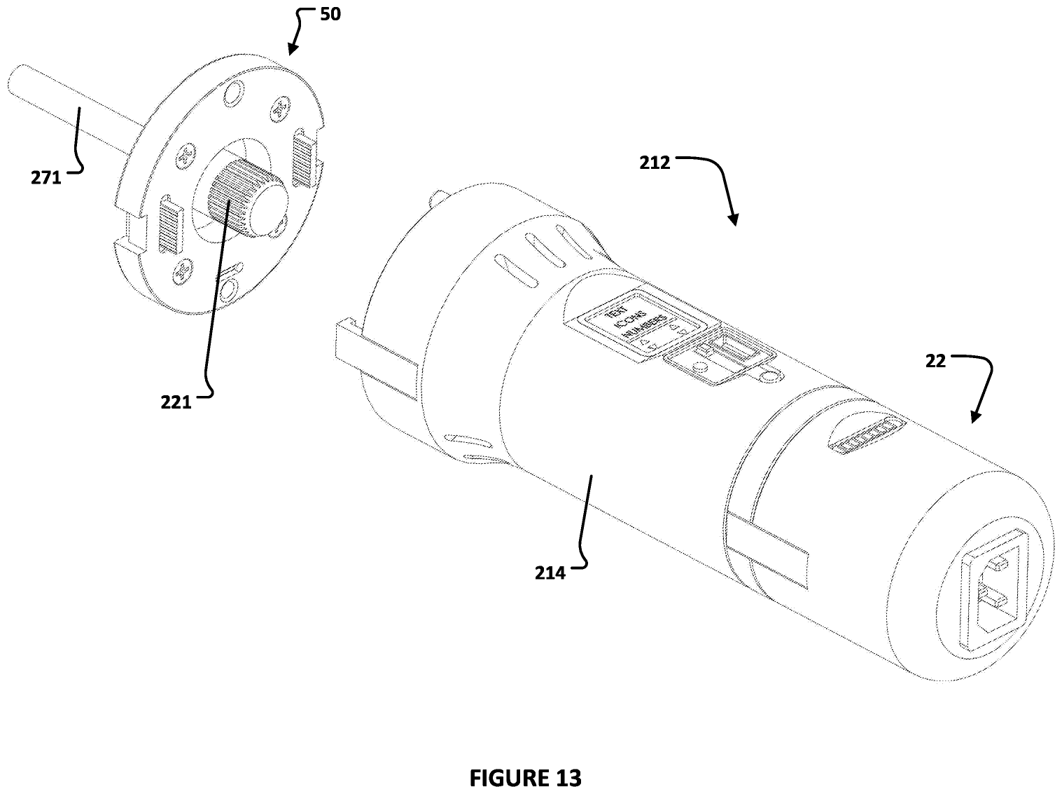

FIGS. 12 and 13 are views of another embodiment of the present disclosure wherein the shaft is fully disposed within the motor housing. A power unit 212 includes a housing 214 and a shaft 218. Splines 220 are defined in a pocket 219 formed by the shaft 218. A shaft 271 associated with a tool module can define splines 221 that mate with splines 220. One advantage of this embodiment is that the driving end of the shaft 218 is at least partially concealed by the housing 214 and therefore less likely to inflict damage if accidentally engaged. While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed:

1. A modular tool system, comprising:
a hand-held power unit including a motor disposed partially within a motor housing, the motor including a shaft at least partially contained in the motor housing;
a plurality of batteries being substantially cylindrical and arranged in contact with a rear lace of the motor housing, a rear face of an initial battery contacting a front face of a subsequent battery, wherein the motor and the plurality of batteries are selectively disposed in electrical communication such that the plurality of batteries can selectively power the motor;
a controller disposed partially within the motor housing, and configured to variably control the electrical communication between the plurality of batteries and the motor such that a speed of rotation of the shaft and a level of torque transmitted through the shaft is variable;
two sensors, in electrical communication with the controller and disposed within the motor housing, arranged on opposite sides of the shall between the shaft and a circumferential edge of the motor housing, each of the two sensors being adjacent an exterior surface of the motor housing defined by the circumferential edge of the motor housing; and
a plurality of tool modules each including a tool module housing individually engageable with the motor housing of the power unit, each of the plurality of tool Modules including a work-engaging portion and a transmission linkage engageable with the shaft whereby the work-engaging portion is driven in motion by the transmission linkage when the transmission linkage is engaged with the shaft and the motor housing and the tool module housing are coupled together, wherein
the shaft is driven in rotation when the motor is powered by the plurality of batteries,
each of the plurality of tool modules includes two identifiers mounted at least in part on an exterior surface of the tool module housing, the two sensors and the two identifiers respectively positioned such that each of the two identifiers is within a range of detection of a corresponding one of the two sensors when the motor housing and the tool module housing are coupled together,
the two identifiers of each of the plurality of tool modules is unique and distinguishable and the two sensors are configured to transmit, based upon each pair of the two identifiers, a signal corresponding to each of the plurality of tool modules,
the controller is configured to determine one of a plurality of different speeds to drive the shaft or one of a plurality of different torques to transmit through the shaft in response to the signal from the two sensors,
the plurality of batteries are releasably-coupled via arms on an aft battery and corresponding receiving slots of the arms on a fore battery, and
a touch-screen display of a user interface is mounted on the motor housing, a user being able to change an output of the shaft through the touch-screen display of the user interface.

2. The modular tool system of claim 1, wherein each of the two sensors includes one of a male plug and a female socket and each of the two identifiers includes the other of the male plug and the female socket.

3. The modular tool system of claim 1, wherein each of the two identifiers is an RFID tag and each of the two sensors is a RFID reader.

4. The modular tool system of claim 1, further comprising
a transmitter in electrical communication with the controller, the controller being configured to transmit and receive signals wirelessly by the transmitter, and
a switch mounted on at least one of the plurality of tool modules, the switch being configured to wirelessly communicate with the controller through the transmitter and engageable by the user to activate the motor.

5. The modular tool system of claim 1, wherein the shaft is fully disposed within the motor housing.

6. The modular tool system of claim 1, further comprising
a transmitter in electrical communication with the controller, the controller being configured to transmit and receive signals wirelessly by the transmitter, wherein
at least a portion of the signals correspond to at least one of
an identity of a particular one of the plurality of tool modules, the particular one of the plurality of tool modules being currently in use, and
a time period of use of the particular one of the plurality of tool modules currently in use.

7. The modular tool system of claim 6, further comprising
a remotely-located computing device having one or more processors, a receiver, and a memory, the receiver being configured to receive the signals from the transmitter, the computing device being configured to store data associated with the signals in the memory, and being physically located remotely from the power unit.

8. The modular tool system of claim 7, wherein the computing device is further defined as configured to concurrently communicate with more than one of the plurality of tool modules.

9. The modular tool system of claim 1, wherein each of the two identifiers is a magnetic strip and each of the two sensors is a magnetic strip reader.

10. The modular tool system of claim 1, wherein the touch-screen display displays a display based on at least one of the two sensors, the two sensors being indicative of a particular one of the two identifiers.

11. The modular tool system of claim 1, wherein the two sensors are arranged on opposite sides of the shaft such that the shaft is a midpoint between the two sensors.

12. The modular tool system of claim 11, wherein the two sensors disposed within the motor housing and adjacent the exterior face of the motor housing activate a change in the output of the shaft when in proximity to corresponding identifiers of the two identifiers.

13. A method of operating a modular tool system, comprising:
powering a plurality of tool modules with a hand-held power unit, the hand-held power unit including
a motor disposed partially within a motor housing, and
a plurality of batteries, each of the plurality of batteries being substantially cylindrical and arranged in contact with a rear ace of the motor housing, a rear face of an initial battery contacting a front face of a subsequent battery, wherein
the plurality of batteries and the motor are disposed in electrical communication such that the plurality of batteries can power the motor, the motor including a shaft at least partially contained within the motor housing and driven in rotation when the motor is powered by the plurality of batteries;
mounting a controller at least partially in the motor housing, the controller being configured to variably control the electrical communication between the plurality of batteries and the or such that a speed of rotation of the shaft and a level of torque transmitted through the shaft is variable;
disposing two sensors within the motor housing, each of the two sensors being arranged on opposite sides of the shaft between the shaft and a circumferential edge of the motor housing and adjacent an exterior surface of the motor housing, the exterior surface being defined by the circumferential edge of the motor housing, the two sensors being in electrical communication with the controller;
configuring each of the plurality of tool modules to include a tool module housing engageable with the motor housing of the power unit, each of the plurality of tool modules including a work-engaging portion and a transmission linkage engageable with the shaft whereby the work-engaging portion is driven in motion by the transmission linkage when the transmission linkage is engaged with the shaft and the motor housing and the tool module housing are coupled together;
mounting two identifiers on an exterior surface of the tool module housing of each of the plurality of tool modules, the two sensors and the two identifiers being respectively positioned within the motor housing and on the tool module housing such that at least one of the two identifiers is within a range of detection of a corresponding at least one of the two sensors when the motor housing and the tool module housing are coupled together;
configuring each of the two identifiers of each of the plurality of tool modules as unique and distinguishable and the two sensors are configured to transmit, based upon each pan of the two identifiers, a signal corresponding to each of the plurality of tool modules;
configuring the controller to determine one of a plurality of different speeds to drive the shaft or one of a plurality of different torques to transmit through the shaft in response to the signal from the two sensors; and
mounting a touch-screen display of a user interface on the motor housing, the touch-screen display of the user interface allowing a user to change an output of the shaft,
wherein the plurality of batteries are releasably-coupled via arms on an aft battery and corresponding receiving slots of the arms on a fore battery.

14. The method of claim 13, further comprising
transmitting, with the controller, signals to a remote computing device having one or more processors, the signals corresponding to at least one of
an identity of a particular one of the plurality of tool modules currently in use, and
a time period of use of the particular one of the plurality of tool modules currently in use, and
storing, in memory of the remote computing device, data associated with the signals transmitted to the remote computing device.

15. The method of claim 14, further comprising
receiving, at the controller, signals from the remote computing device.

16. The method of claim 15, further comprising
changing, in response to the signals from the remote computing device, at least one of the plurality of different speeds to drive the shaft or one of the plurality of different torques to transmit through the shaft, and
determining, at the remote computing device, when a cumulative time period of use of the particular one of the plurality of tool modules reaches a predetermined value.

17. The method of claim 16, further comprising:
controlling, concurrently and with the remote computing device, a plurality of hand-held power units.

18. The method of claim 17, further comprising:
directing power into the plurality of batteries from a grid.
